(19) United States
(12) Patent Application Publication
(10) Pub. No.: US 2013/0038230 A1
(43) Pub. Date: Feb. 14, 2013

(54) METHOD AND APPARATUS TO FACILITATE COUPLING AN LED-BASED LAMP TO A FLUORESCENT LIGHT FIXTURE

(71) Applicants: Wendell Brown, Henderson, NV (US); Jonathan Fram, Beverly Hills, CA (US); Eric Wang, Los Angeles, CA (US)

(72) Inventors: Wendell Brown, Henderson, NV (US); Jonathan Fram, Beverly Hills, CA (US); Eric Wang, Los Angeles, CA (US)

(73) Assignee: NULARIS INC., West Hollywood, CA (US)

(21) Appl. No.: 13/586,447

(22) Filed: Aug. 15, 2012

Related U.S. Application Data
(63) Continuation-in-part of application No. 13/414,921, filed on Mar. 8, 2012.
(60) Provisional application No. 61/523,613, filed on Aug. 15, 2011.
(60) Provisional application No. 61/451,816, filed on Mar. 11, 2011.

(51) Int. Cl. H05B 37/00; H05B 37/02

(52) U.S. Cl. 315/201; 315/312; 315/294

(57) ABSTRACT

Methods and apparatus to facilitate coupling a light-emitting diode (LED)-based lamp to an electronic or inductive fluorescent light fixture (typically with ballast). An LED-based lamp may include circuitry that simulates an electrical behavior of a fluorescent lamp, and can be installed and operate in the fixture without any modification to the fixture. The LED-based lamp may also include one or more LEDs that are controlled by the circuitry.

### RELATED APPLICATIONS

This application claims priority to U.S. Provisional Application No. 61/523,613, filed on 15 Aug. 2011, the contents of which are herein incorporated by reference. Also, this application is a continuation-in-part of U.S. patent application Ser. No. 13/414,921, filed 8 Mar. 2012, which claims priority to U.S. Provisional Application No. 61/451,816, filed 11 Mar. 2011.

### BACKGROUND

1. Technical Field

This disclosure relates to light-emitting apparatuses. More specifically, this disclosure relates to methods and apparatuses to facilitate coupling a light-emitting diode (LED)-based lamp to a fluorescent light fixture.

2. Related Art

There are millions of existing florescent light fixtures installed in businesses, buildings, homes, schools, malls, factories and other locations. A new generation of LED lights offers more energy efficiency and longer life.

### SUMMARY

Some embodiments of the invention described herein provide a plug-compatible LED-based lamp apparatus for replacing a fluorescent light bulb, and methods to facilitate coupling such an LED-based lamp to an existing inductive or electronic fluorescent light fixture (typically with ballast).

Many existing florescent light fixtures are not directly compatible with plug-in LED light lamps, on a “plug-n-play” basis, without altering the existing fixture wiring (for example, by removing the starter, shorting across the ballast, etc). Some embodiments of the invention described herein provide circuitry that may be contained within the LED-based lamp and that allows the existing florescent circuitry to directly drive the LED-based lamp without modification to the existing florescent fixture or circuitry.

### BRIEF DESCRIPTION OF THE FIGURES

FIG. 1 illustrates a block diagram for an LED-based lamp in accordance with some embodiments of the invention described herein.

FIG. 2 illustrates a process to operate an LED-based lamp that is coupled to a fluorescent light fixture in accordance with some embodiments of the invention described herein.

FIG. 3 illustrates a block diagram for an LED-based lamp in accordance with some embodiments of the invention described herein.

FIG. 4 is a diagram of an LED-based lamp according to some embodiments of the invention.

FIG. 5 is a diagram of another LED-based lamp according to some embodiments of the invention.

FIGS. 6A and 6B are an image and a diagram of an LED-based lamp for replacing a fluorescent bulb, according to some embodiments of the invention.

FIG. 7 is another image of an LED-based lamp for replacing a fluorescent bulb, according to some embodiments of the invention.

FIG. 8 is a diagram of an LED-based lamp for replacing a fluorescent bulb, according to some embodiments of the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a non-transitory computer-readable storage medium, which may be any device or medium that can store code and/or data for use by a computer system. The term non-transitory computer-readable storage medium includes all computer-readable storage mediums with the sole exception of a propagating electromagnetic wave or signal. This includes, but is not limited to, volatile memory, non-volatile memory, magnetic and optical storage devices such as disk drives, magnetic tape, compact discs, DVDs (digital versatile discs or digital video discs), or other non-transitory computer-readable media now known or later developed.

As used in this disclosure, the term “lamp” refers to an apparatus that converts electricity into light. In some fluorescent lamps, electricity is used to excite mercury atoms, and the excited mercury atoms produce ultraviolet light. The ultraviolet light, in turn, causes phosphor (which is also in the lamp) to fluorescence, thereby producing visible light.

Operating a fluorescent lamp requires circuitry to start the lamp by ionizing the vapor in the lamp and to limit the amount of current flowing through the vapor once the lamp has been started. Typical florescent lamp fixtures contain either an electronic or an inductive (magnetic) ballast. They also contain a starter circuit that fires a short, high-voltage spike to initially light the florescent lamp by striking an arc across the ionized vapor. Neither of these are necessary for LED lights, but it is desirable (for ease of upgrade) to couple a replacement LED light to work with the existing florescent lamp circuitry (i.e., a ballast and/or starter).

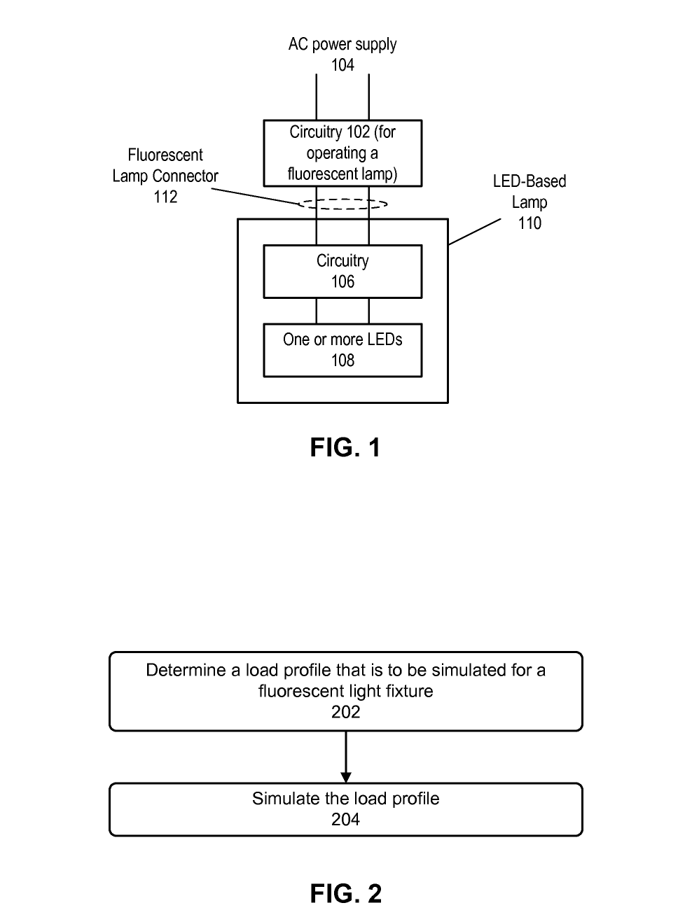

FIG. 1 illustrates a block diagram for an LED-based lamp in accordance with some embodiments described herein. The LED-based lamp shown in FIG. 1 is for illustration purposes only and is not intended to limit the embodiments described herein. Accordingly, modifications and variations will be apparent to practitioners skilled in the art.

Circuitry 102 is part of a fluorescent lamp fixture, and is specifically designed to operate fluorescent lamps. A fluorescent lamp (not shown) can be coupled to circuitry 102 via fluorescent lamp connector 112. Circuitry 102 receives power from alternating current (AC) power supply 104. Circuitry 102 starts the fluorescent lamp by providing a high-voltage spike to the lamp, and then regulates the current in the lamp after the lamp has been started. If a lamp that does not electrically behave like a fluorescent lamp is coupled to circuitry 102, the lamp may malfunction and/or cause circuitry 102 to malfunction.

An LED-based lamp does not electrically behave like a fluorescent lamp. Therefore, such a lamp ordinarily could not be directly coupled to a light fixture that is designed for a fluorescent lamp. Some embodiments of the invention described herein, however, provide an LED-based lamp (e.g., LED-based lamp 110) that is capable of being coupled to a fluorescent lamp connector (e.g., fluorescent lamp connector 112) and that is compatible with circuitry that is designed to operate a fluorescent lamp (e.g., circuitry 102).

LED-based lamp 110 includes circuitry 106 and one or more LEDs 108. Circuitry 106 simulates the electrical behavior of a fluorescent lamp, thereby causing circuitry 102 to operate correctly. Circuitry 106 also controls and provides power to one or more LEDs 108. Circuitry 106 can include analog and/or digital components.

FIG. 2 illustrates a process to operate an LED-based lamp that is coupled to a fluorescent light fixture in accordance with some embodiments described herein.

The process begins by determining a load profile that is to be simulated for a fluorescent light fixture (operation 202). According to one definition, the term “load profile” refers to the variation of an impedance value over time. For example, an illustrative load profile may specify that the load is equal to a first impedance value during the first 100 milliseconds, and thereafter the load tapers off from the first impedance value to a second impedance value over the next 5 seconds.

Thus, the load profile of a fluorescent tube is the variation of the impedance value over time of the fluorescent tube that is seen by circuitry 102. According to one definition, the term “load profile that is to be simulated for a fluorescent light fixture” is the load profile that causes the circuitry in the fluorescent light fixture (e.g., circuitry 102) to operate in substantially the same way it would have operated if a fluorescent bulb had been coupled to the fluorescent lamp connector (e.g., fluorescent lamp connector 112) of the fluorescent light fixture.

In some embodiments, circuitry 106 in the LED-based lamp 110 can determine whether the LED-based lamp is plugged into an electronic or a mechanical (inductive) ballast. This can be determined using several approaches.

In a first approach, circuitry 106 can analyze the frequency (chop) of the incoming current. Electronic ballasts are similar to switching power supplies and thus circuitry 106 can examine the incoming voltage/current (output from the electronic ballast) and sense a high-frequency chop as produced by an electronic ballast. An inductive ballast, on the other hand, does not produce a high-frequency chop.

In a second approach, circuitry 106 can vary the load (on the electronic or inductive ballast) to detect if and how the frequency changes (if so, circuitry 106 can confirm that the LED is plugged into an electronic ballast).

In a third approach, a manual DIP (dual in-line package) switch setting or other selection mechanism can be used to toggle through configuration options. The switch (which may be located on the LED-based lamp) could be set to auto-configure or set to manually configure to drive a particular load program. Illustratively, a human installer may manually configure the LED-based lamp's DIP switch to correspond to the ballast type/model/manufacturer. Circuitry 106 can sense the DIP switch setting and provide a corresponding load to circuitry 102.

In a fourth approach, circuitry 106 can analyze the time ramp of voltage/current supplied by the ballast—either in start mode or continual. The ramp of the voltage/current supplied ballast is different for electronic and magnetic ballasts. Therefore, the time ramp can be used to detect the type of ballast.

In a fifth approach, circuitry 106 can analyze other characteristics of an inductor load (inductive kick, time ramps, reverse kick when the ballast disconnects, etc.) to determine whether circuitry 102 includes an electronic or magnetic ballast.

In a sixth approach, circuitry 106 can perform an “auto-configure” process in which LED-based lamp 110 cycles through, and tests, which mode or modes work the best, and then circuitry 106 can store a best mode, which can then be used subsequently when LED-based lamp 110 is turned on. For example, a simple “reset” switch or a “run auto-configure” switch could be set on LED-based lamp 110 once LED-based lamp 110 has been installed.

In this embodiment, LED-based lamp 110 may include read-only memory (ROM) or Flash memory, which LED-based lamp 110 can use to store the mode that was determined during the auto-configure process. In some embodiments, if LED-based lamp 110 hasn't been configured or has been reset (e.g., LED-based lamp 110 is fresh from the factory) then LED-based lamp 110 may perform the “auto-configure” process itself when it powers up the first time.

In some embodiments, LED-based lamp 110 could also flash at certain rates to visually indicate to the installer that it is currently self-configuring, or indicate that it is in a particular operational mode, and/or indicate if an error condition has occurred.

After the load profile that is to be simulated for the fluorescent light fixture has been determined, the process can simulate the load profile (operation 204). In one implementation, circuitry 106 might include a processor and a memory, wherein the memory can store instructions that, when executed by the processor cause LED-based lamp 110 to simulate the electrical behavior of a particular type of fluorescent lamp. For example, the memory may store instructions for a set of “simulation modes”, wherein each simulation mode corresponds to a different “load program” that creates a load onto the ballast which suits the drive characteristics of an electronic ballast or a mechanical (inductive) ballast. There could be multiple load programs that illustratively may be configured by auto-detection of the ballast type or by manual configuration (e.g., based on a DIP switch that is manually configured by a human installer to correspond to the ballast type/model/manufacturer).

The load program can simulate the electrical behavior that is expected of the simulated fluorescent lamp during the starting phase and also when the simulated fluorescent lamp has been turned on. Specifically, the current draw that circuitry 106 emulates when the simulated fluorescent lamp has been turned on might be different depending on whether circuitry 106 detected an electronic ballast or a mechanical (inductive) ballast.

In some embodiments, an inductive ballast in circuitry 102 may not operate properly if the current draw is too low. Multiple approaches can be used to provide an appropriate level of current draw. In some embodiments, circuitry 106 can perform slow time slicing of the LED load. In these embodiments, circuitry 106 includes a capacitor that can buffer enough power to keep the LEDs on for a first time duration (e.g., 10 seconds).

Circuitry 106 presents a normal current load to the ballast in circuitry 102 for a second time duration (e.g., 1 second), and fills up the capacitor. Next, circuitry 106 disconnects from circuitry 102 (and therefore disconnects from the ballast in circuitry 102). After circuitry 106 disconnects, the LEDs remain on by drawing current from the capacitor for a third time duration. In some embodiments, the third duration is equal to the difference between the first and second time durations (e.g., 9 seconds). At the end of the third time duration, circuitry 106 reconnects to circuitry 102 and recharges the capacitor by presenting a normal load to circuitry 102 for a duration that is equal to the first time duration.

This relatively “slow time switching” technique (“slow” because it cycles in seconds, not milliseconds) can be used for both electronic as well as inductive ballasts. The “load” could start and/or end in a binary fashion (on/off) or in smaller steps. For example, the load could slowly rise or fall over 256 steps, over a period of one second. This stepped approach may help avoid sudden stresses on the ballast, make the ballast last longer and/or reduce noise (e.g., avoid a 1-second buzz and/or popping sound every 10 seconds).

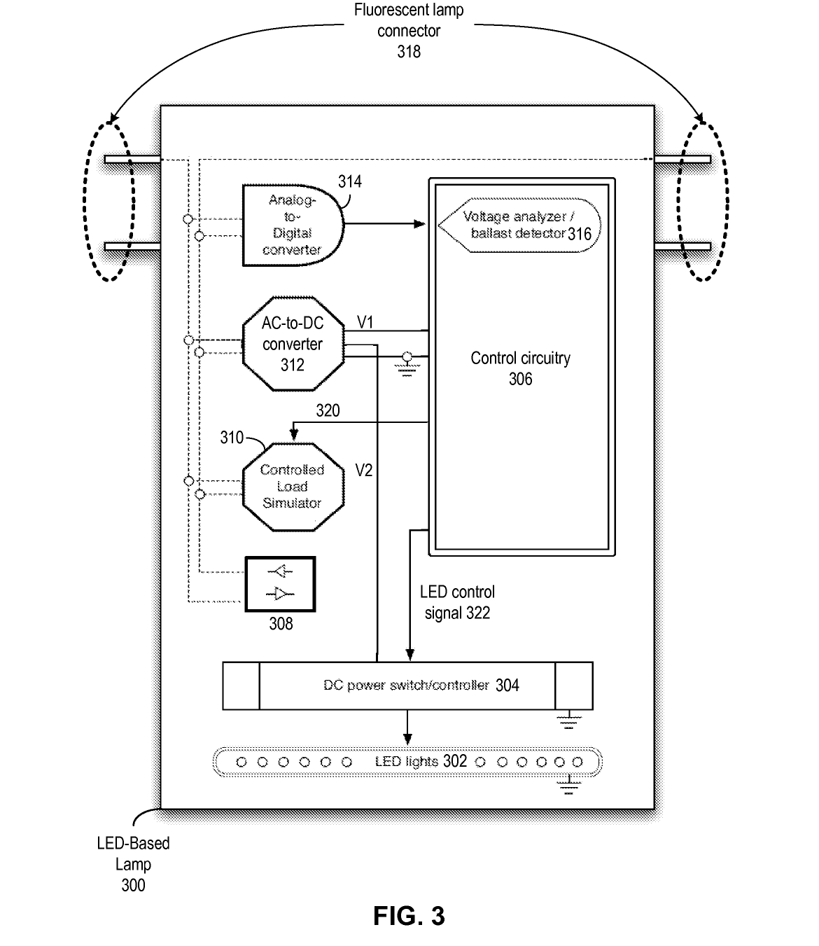

FIG. 3 illustrates a block diagram for an LED-based lamp in accordance with some embodiments of the invention described herein.

LED-based lamp 300 includes analog-to-digital converter (ADC) 314, voltage analyzer/ballast detector 316, AC (alternating current)-to-DC (direct current) converter 312, control circuitry 306, controlled load simulator 310, one or more zener diodes 308, DC power switch/controller 304, and LED lights 302. One or more fluorescent lamp connectors 318 are used to couple LED-based lamp 300 into a fluorescent lamp fixture.

The starter's high-voltage spike can be effectively shunted through the use of one or more zener diodes 308. In other embodiments, the one or more zener diodes can be replaced with a silicon controlled rectifier, and/or a high-voltage TRIAC (triode for alternating current) can be used to effectively short-out the starter spike.

Note that the high-voltage spike is still produced by the florescent starter, but the high-voltage spike is rendered harmless by the shorting effect of one or more zener diodes 308 (or other circuitry that is capable of shorting the high-voltage spike). If the florescent starter module is manually removed, then the embodiment may not require zener diodes 308 and/or other circuitry that is capable of shorting the high-voltage spike.

AC-to-DC converter 312 can supply DC power to control circuitry 306 and to LED lights 302 through DC power switch/controller 304. In some embodiments, AC-to-DC converter 312 can supply different DC voltages to different parts of LED-based lamp 300. For example, AC-to-DC converter 312 can supply voltage V1 to control circuitry 306 and voltage V2 to LED lights 302 through DC power switch/controller 304.

ADC 314 can sense the voltage across two wires of fluorescent lamp connector 318, and convert the voltage value into a digital value that can be processed by control circuitry 306. Specifically, control circuitry 306 can include voltage analyzer/ballast detector 316 to determine whether the fluorescent light fixture uses an electronic or inductive ballast based on the digital value provided by ADC 314.

Control circuitry 306 can generate control signal 320 based on a load profile. Control load simulator 310 (also referred to as load simulator circuitry in this disclosure) can present a dynamic (i.e., time-varying) load across two wires of fluorescent lamp connector 318 based on control signal 320 that is received from control circuitry 306. For example, controlled load simulator 310 can present a load that is equal to a first impedance value for 100 milliseconds, and thereafter present a load that tapers off from the first impedance value to a second impedance value over the next 5 seconds. Control circuitry 306 can also provide LED control signal 322 to DC power switch/controller 304 to turn on, turn off and/or increase/decrease intensity of LED lights 302.

As explained above, circuitry in LED-based lamp 300 acts to effectively simulate the current/voltage consumption of a florescent tube, as seen by the ballast. Effectively, the circuitry in LED-based lamp 300 tricks the ballast into producing the necessary voltage/current characteristics in order to make the ballast think it's driving a florescent tube.

In some embodiments, control circuitry 306 can include a low-performance processor with RAM (random access memory), ROM (read only memory) and/or analog control circuitry. In some embodiments, control circuitry 306 is reset or activated by the high-voltage “starter spike” produced by the existing florescent fixture's starter module. In some embodiments, control circuitry 306 is reset or activated by the presence of incoming voltage output of the ballast. Once control circuitry 306 is reset or activated, it then begins a time-controlled artificial resistance and/or inductive load to simulate the load characteristics of a typical florescent tube. In this manner, control circuitry 306 effectively tricks the ballast into believing that it is driving an actual florescent tube.

### Variations and Modifications

Some embodiments of the invention described herein allow direct replacement of a typical florescent tube with an LED-based lamp, with no changes needed to the florescent fixture, and all components (including the ballast) can remain in line. In some embodiments, the extra circuitry (e.g., circuitry 106 shown in FIG. 1) is contained within the replacement LED-based lamp, which alleviates the need for manual rewiring or changing of the florescent fixture or its wiring.

Some embodiments provide an LED-based lamp that is configurable to best match the expected load of the ballast to which it is connected. Selecting the configuration mode could be done via an automated process or via a manual setting configuration setting. In some embodiments, the LED-based lamp is configurable using one or more controls (e.g., a DIP switch) to set or adjust one or more characteristics of one or more LEDs in the LED-based lamp. These characteristics include, but are not limited to, brightness, color, whether an LED turns on or off suddenly or gradually, whether an LED is capable of being dimmed, and whether an LED is capable of being programmed to turn on or off after a predetermined duration.

Some embodiments described herein provide an LED-based lamp that is designed to be physically plug-compatible with existing fluorescent fixtures/connectors, wherein the LED-based lamp is configured to be electronically compatible with the ballast it is connected to. In some embodiments, one or more characteristics of one or more LEDs are capable of being configured by a communication device (e.g., based on information received from the communication device over a wireless channel such as WiFi® or Bluetooth®), by detection of an electromagnetic signal (e.g., time of day radio broadcast, bits detected in a TV signal vertical broadcasts), by detection of an audio signal (e.g., voice activated, clap activated), and/or by manual configuration by the user (e.g., by turning an existing switch on/off/on/off a certain number of times within a short period of time). A communication device refers to any device that is capable of communicating with other devices over a wired or wireless channel, such as (but not limited to) a smart phone (e.g., an iPhone), a tablet computer, a laptop computer, a desktop computer, a wireless router, a cell tower, etc.

In some embodiments, an LED-based lamp's output (brightness, color, etc.) can be “turned on” and/or “turned off” gradually (e.g., by using 256 steps) to create a more visually appealing on/off operation (instead of a sudden on/off operation). In some embodiments, the LED-based lamp is configured so that a user could “signal” (on/off) to the bulb to “stop” the dimness at a certain point in its gradual turn-on cycle, thereby allowing the user to select a certain dim level according to the time between the user's cycling of the existing wall power switch.

In some embodiments, the LED-based lamp is designed either as a new standalone device or as an existing fluorescent bulb replacement device (as determined by the LED-based lamp's size/connectors to match existing fixtures).

Some methods of coupling an LED-based lamp to an existing fluorescent light fixture, such as those described above and/or described in conjunction with FIG. 2, may be particularly suitable with apparatus incorporating digital circuitry, such as an apparatus depicted in FIG. 3.

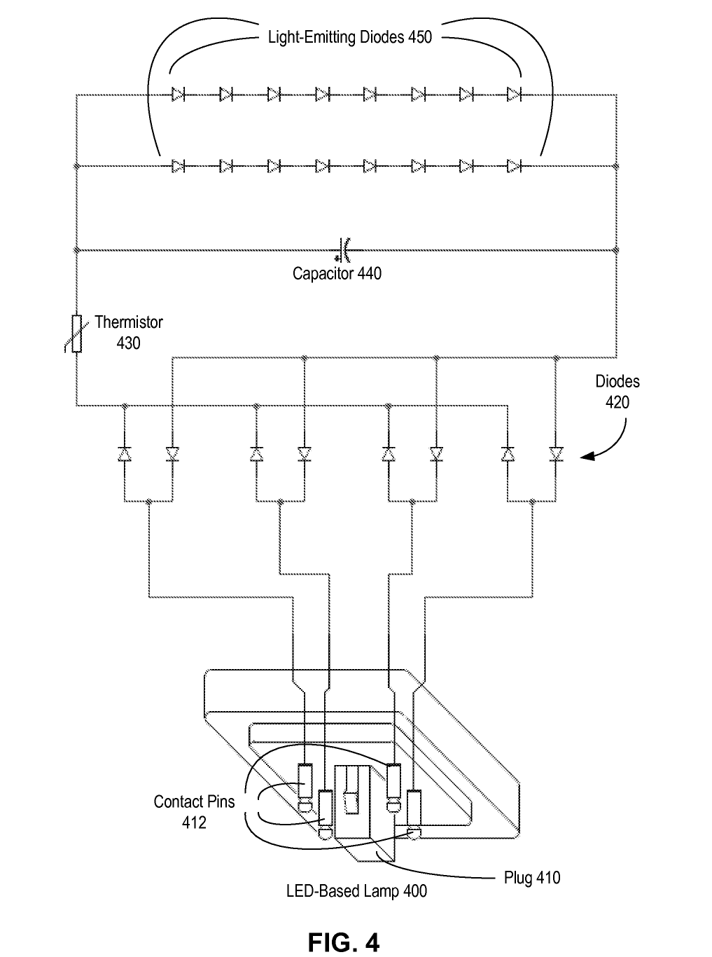

For apparatus that employ analog circuitry, such as those depicted in FIGS. 4-8 and/or described below, the load may be determined by the configuration of LEDs and/or other circuit components. In yet other embodiments of the invention, a fluorescent light bulb may be replaced with an LED-based lamp that features aspects of multiple apparatus depicted in different figures.

FIG. 4 is a diagram of an LED-based lamp according to some embodiments of the invention. In these embodiments, the lamp can directly replace a fluorescent bulb, in a fluorescent light fixture, without modification of the fixture.

LED-based lamp 400 provides a plug-and-play replacement for a fluorescent bulb, without digital circuitry. The base of lamp 400 mimics that of a fluorescent bulb (e.g., a G24 model), including plug 410 and four contact pins 412 for connecting circuitry of LED-based lamp 400 to circuitry of the fluorescent light fixture in which it will be installed (e.g., circuitry 102 of FIG. 1).

Diodes 420, which may be configured to simulate a bridge rectifier, operate to convert AC to DC for powering LEDs 450.

In some implementations, thermistor 430 is a 1 amp positive temperature coefficient (PTC) thermistor and prevents excessive current or voltage from damaging LEDs 550 and/or other components of the lamp.

In some implementations, capacitor 440 is rated at 22 micro-Farads and 100 volts, and helps promote an even supply of DC power to the LEDs.

Light-emitting diodes 450 provide light when powered, and may be arranged in different configurations in different embodiments of the invention.

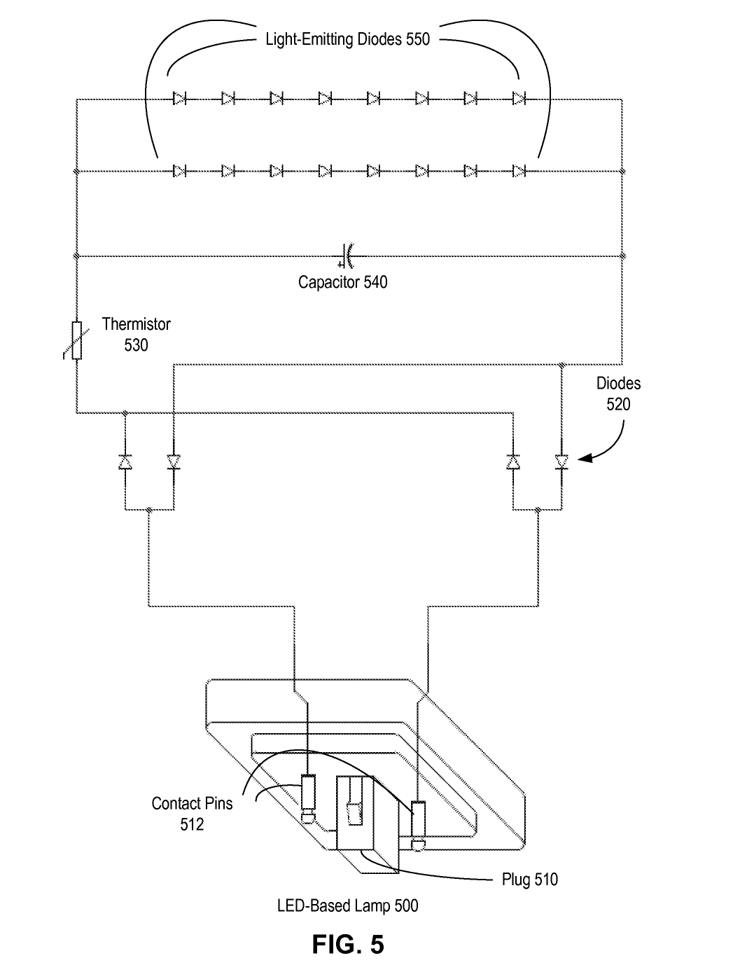

FIG. 5 is a diagram of another LED-based lamp according to some embodiments of the invention. As with lamp 400 of FIG. 4, LED-based lamp 500 can directly replace a fluorescent bulb, in a fluorescent light fixture, without modification of the fixture. A difference between lamps 400 and 500 is that lamp 500 comprises fewer pins 512. Plug 510 remains compatible with the fluorescent light fixture in which lamp 500 will be installed.

Components such as diodes 520, thermistor 530, capacitor 540 and light-emitting diodes 550 may have similar or the same functions and/or properties as their counterparts of lamp 400.

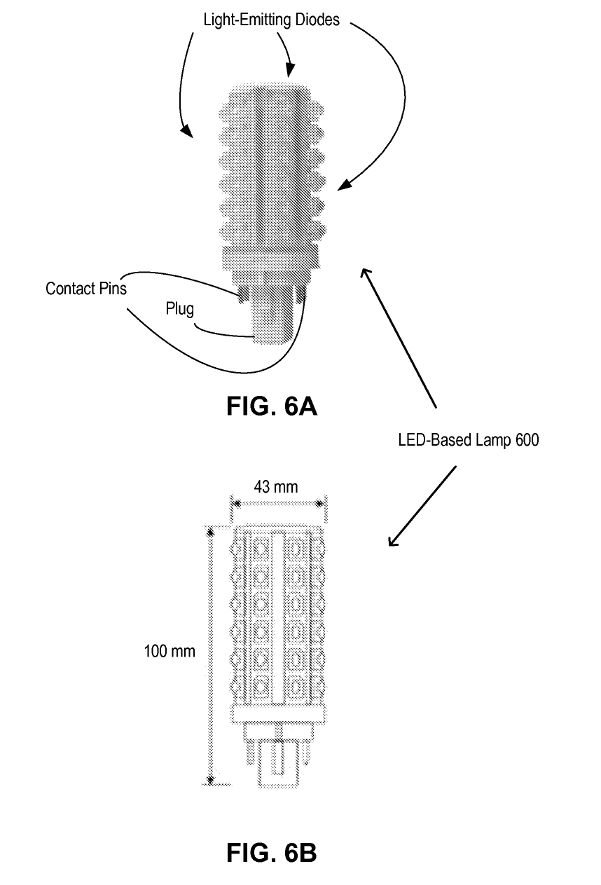

FIGS. 6A and 6B are an image and a diagram of an LED-based lamp for replacing a fluorescent bulb, according to some embodiments of the invention. As shown in these figures, LED-based lamp 600 features multiple columns or rows of LEDs arrayed or aligned around a columnar base. Multiple contacts pins are provided, and the contact pins and plug are compatible with a corresponding receptacle of a fluorescent light fixture, thereby allowing lamp 600 to replace a fluorescent bulb with no modification to the fixture.

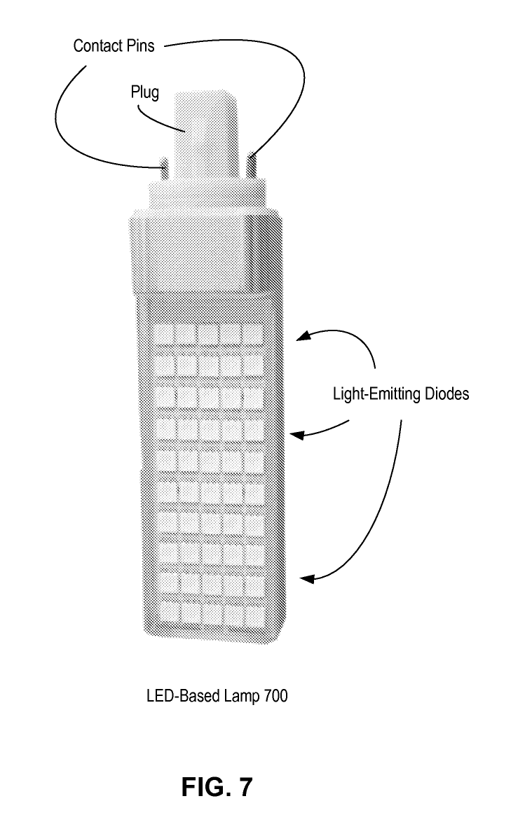

FIG. 7 is another image of an LED-based lamp for replacing a fluorescent bulb, according to some embodiments of the invention. LED-based lamp 700 features an array of LEDs on one flat or relatively flat side of lamp 700. One benefit of this configuration is that light produced by the lamp is focused primarily in one direction (orthogonal to the face on which the LEDs are arrayed), instead of dissipating the light from different LEDs in different directions.

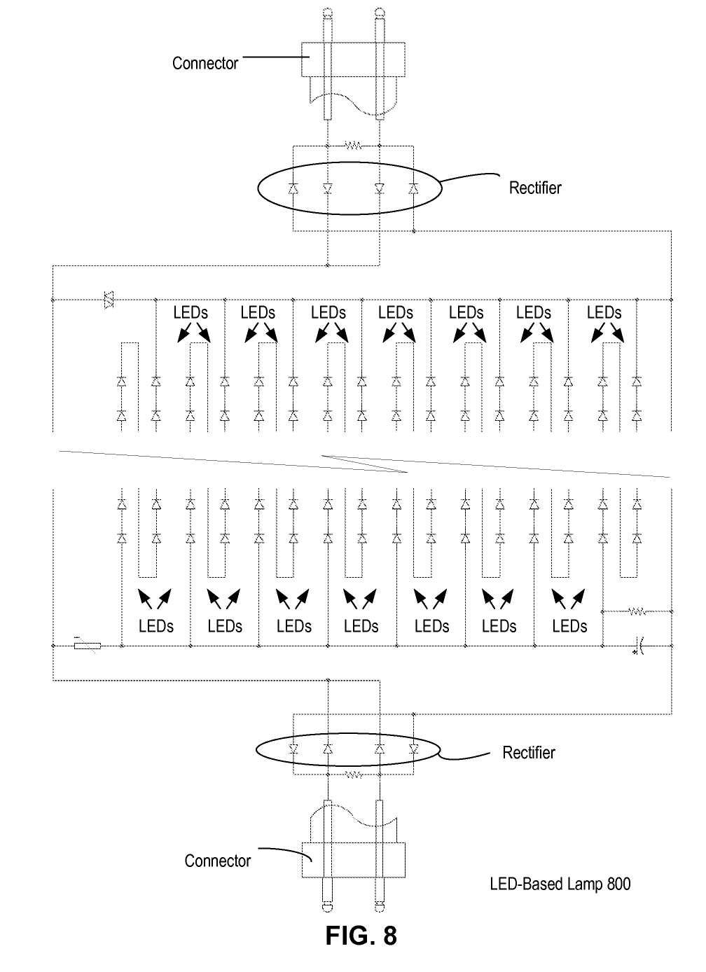

FIG. 8 is a diagram of an LED-based lamp for replacing a fluorescent bulb, according to some embodiments of the invention. In these embodiments, lamp 800 can replace a tubular fluorescent light bulb, such as a model T8, which features contact pins at both ends of a tubular body. For compatibility with the fluorescent light fixture, lamp 800 includes connectors that include contact pins and that can plug into and operate with the fixture with no modification to the fixture. Rectifiers coupled to the connectors convert AC received from a fluorescent light fixture into DC for driving the LEDs.

Although FIG. 8 illustrates resistors between each rectifier and a connector of LED-based lamp 800, in other embodiments they may be omitted. The resistors, if employed, can help simulate a large load. For example, in some implementations, other components of lamp 800 (e.g., rectifier, LEDs) may not generate a suitable load for a fluorescent light fixture, and the optional resistors may help increase the perceived load.

LED-based lamp 800 comprises multiple light-emitting diodes, which may be arrayed or aligned in different configurations in different implementations. For example, a body of lamp 800 may be comparable to that of the T8 fluorescent bulb (i.e., tubular) and the LEDs may be positioned about the surface to provide light in all (i.e., 360 degrees) or almost all radial directions from a central axis of the lamp. As but one alternative, lamp 800 may have one or more flat, relatively flat or somewhat convex or concave sides on which all or a majority of the LEDs are concentrated, so as to concentrate light output of the lamp in a particular arc.

LED-based lamps depicted in the accompanying figures are merely illustrative, and in no way limit the configuration, alignment, orientation, position, size, number, color or other characteristics of LED-based lamps of other embodiments of the invention.

Further, an LED-based lamp described above may be compatible with multiple different models or versions of fluorescent light fixtures. For example, an LED-based lamp provided herein can accept different amounts of power, different currents and/or different voltages and still function correctly, and so the same lamp may be installed in fixtures that output different power, different current and/or different voltage.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus, comprising:
a first connector compatible with a first receptacle of a fluorescent light fixture;
one or more light-emitting diodes (LEDs); and
analog circuitry for providing direct current to the one or more LEDs from the fluorescent light fixture.

2. The apparatus of claim 1, wherein the analog circuitry comprises:
a rectifier converting alternating current to the direct current; and
a capacitor.

3. The apparatus of claim 2, further comprising a thermistor.

4. The apparatus of claim 1, wherein the one or more LEDs are positioned on a single, substantially flat, side of the apparatus.

5. The apparatus of claim 1, wherein:
the apparatus comprises one or more substantially flat exterior surfaces; and
the one or more LEDs are positioned on a first substantially flat exterior surface of the apparatus.

6. The apparatus of claim 1, further comprising a second connector compatible with a second receptacle of the fluorescent light fixture.

7. The apparatus of claim 1, wherein:
the apparatus is substantially columnar in shape; and
the one or more LEDs are aligned about the substantially columnar shape.

8. The apparatus of claim 1, further comprising a user-operable switch for adjusting the apparatus to accept a power output of the fluorescent light fixture.

9. The apparatus of claim 1, further comprising a dual in-line package switch to configure one or more characteristics of the one or more LEDs.

10. The apparatus of claim 9, wherein a characteristic is one of:
brightness, color, whether an LED turns on/off suddenly or gradually, whether an LED is capable of being dimmed, and whether an LED is capable of being programmed to turn on/off after a predetermined duration.

11. The apparatus of claim 1, wherein the fluorescent light fixture receives and operates the apparatus without modification to the fluorescent light fixture other than receipt of the apparatus.

12. Apparatus for replacing a fluorescent light bulb without alteration of a fluorescent light fixture in which the fluorescent light bulb is replaced, the apparatus comprising:
means for coupling the apparatus to the fluorescent light fixture; and
one or more light-emitting diodes (LEDs).

13. The apparatus of claim 12, further comprising:
means for converting alternating current received from the fluorescent light fixture into direct current.

14. The apparatus of claim 13, further comprising:
means for smoothing the direct current.

15. The apparatus of claim 12, further comprising:
means for accepting a high voltage spike from the fluorescent light fixture without failure of the apparatus.

16. The apparatus of claim 12, wherein the apparatus does not include a fluorescent light bulb.
